(19) United States
(12) Patent Application Publication
(10) Pub. No.: US 2025/0304000 A1
(43) Pub. Date: Oct. 2, 2025

(54) ENTRY SYSTEM AND ENTRY CONTROL METHOD

(71) Applicant: HONDA MOTOR CO., LTD., Tokyo (JP)

(72) Inventors: Satoshi Kotoura, Tokyo (JP); Takuya Suzuki, Tokyo (JP); Hiroki Yoshikawa, Tokyo (JP); Seonghun Lee, Tokyo (JP); Genki Inohana, Tokyo (JP); Mitsunori Nishino, Tokyo (JP); Tomoya Okuda, Tokyo (JP)

(21) Appl. No.: 19/060,226

(22) Filed: Feb. 21, 2025

(30) Foreign Application Priority Data
Mar. 29, 2024 (JP) 2024-055946

(51) Int. Cl. B60R 25/01; B60R 25/24; B60R 25/25; B60R 25/30; B60R 25/31; G06V 20/56; G06V 40/16; G06V 40/20; G07C 9/00; G07C 9/25

(52) U.S. Cl. CPC B60R 25/01; B60R 25/24; B60R 25/25; B60R 25/305; B60R 25/31; G06V 20/56; G06V 40/172; G06V 40/25; G07C 9/00309; G07C 9/00563; G07C 9/25; G06V 2201/07; G07C 2009/00793; G07C 2209/63

(57) ABSTRACT

An entry system includes: a detection unit configured to detect a target person approaching a moving body; an acquisition unit configured to acquire an image of the target person at a prescribed time interval; a determination unit configured to determine presence/absence of a boarding intention of the target person to the moving body based on movement of the target person recognized from the image; a key authentication unit configured to search an electronic key present around the moving body and to authenticate the electronic key; and a control unit configured to control an operation of the moving body. When authentication of the electronic key is a success in the key authentication unit, the control unit automatically unlocks a door of the moving body when the determination unit determines that the target person has the boarding intention.

### INCORPORATION BY REFERENCE

The present application claims priority under 35 U.S.C. § 119 to Japanese Patent Application No. 2024-055946 filed on Mar. 29, 2024. The content of the application is incorporated herein by reference in its entirety.

### BACKGROUND OF THE INVENTION

### Field of the Invention

The present invention relates to an entry system and an entry control method for a moving body.

### Description of the Related Art

In recent years, an approach of providing access to a sustainable transportation system considering even vulnerable people like aged people, people with disabilities and children among traffic participants is gaining momentum. Towards the realization, the focus is on research and development for further improving traffic safety and convenience through development regarding vehicle accessibility.

Japanese Patent Laid-Open No. 2018-84109 discloses a locking system capable of controlling locking/unlocking of private space of a vehicle. The locking system performs unlocking based on results of key authentication and biological authentication to enable access to the vehicle.

Now, for vehicle accessibility, a problem is to enable a proper user of a vehicle to smoothly perform entry into the vehicle.

In order to solve the above-described problem, an object of the present application is to enable smooth entry of a user who intends to perform entry into a moving body without complicating authentication processing, thereby contributing to development of a sustainable transportation system.

### SUMMARY OF THE INVENTION

One mode of the present invention aspect is an entry system including: a detection unit configured to detect a target person approaching a moving body; an acquisition unit configured to acquire an image of the target person at a prescribed time interval; a determination unit configured to determine presence/absence of a boarding intention of the target person to the moving body based on movement of the target person recognized from the image; a key authentication unit configured to search an electronic key present around the moving body and to authenticate the electronic key; and a control unit configured to control an operation of the moving body. When authentication of the electronic key is a success in the key authentication unit, the control unit automatically unlocks a door of the moving body when the determination unit determines that the target person has the boarding intention.

Another mode of the present invention aspect is an entry control method conducted by a computer of an entry system that controls unlocking of a door of a moving body, and the method includes: a detection step of detecting a target person approaching the moving body; an acquisition step of acquiring an image of the target person at a prescribed time interval; a determination step of determining presence/absence of a boarding intention of the target person to the moving body based on movement of the target person recognized from the image; a key authentication step of searching an electronic key present around the moving body and authenticating the electronic key; and a control step of controlling an operation of the moving body. In the control step, when authentication of the electronic key is a success in the key authentication step, the door of the moving body is automatically unlocked when it is determined that the target person has the boarding intention in the determination step.

According to the present invention aspect, it is possible to enable a proper user of a moving body to smoothly perform entry into the moving body without complicating authentication processing.

### BRIEF DESCRIPTION OF THE DRAWINGS

FIG. 1 is a diagram illustrating an example of a configuration of a moving body loaded with an entry system according to one embodiment of the present invention;

FIG. 2 is a diagram illustrating a configuration of the entry system;

FIG. 3 is a diagram for describing a detection operation of a target person approaching the moving body; and

FIG. 4 is a flowchart illustrating a procedure of an operation in the entry system.

### DETAILED DESCRIPTION OF THE INVENTION

Hereinafter, embodiments of the present invention will be described with reference to the drawings.

### [1. Configuration of Vehicle]

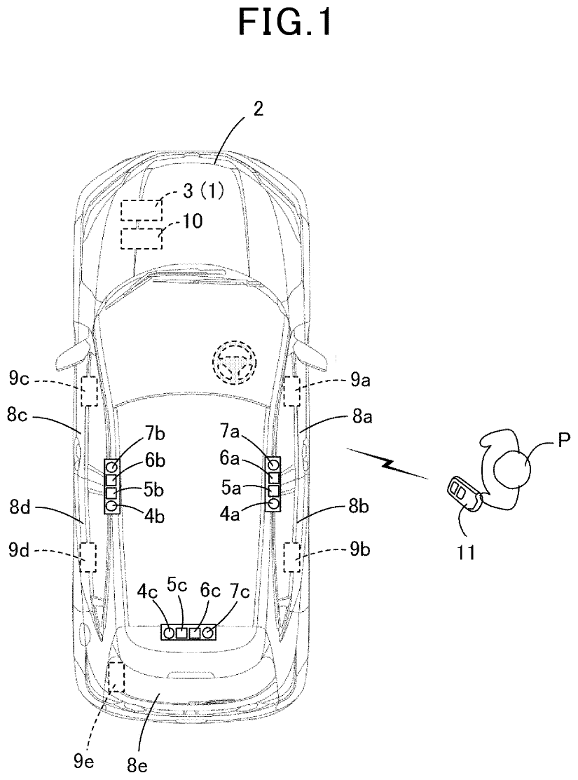

FIG. 1 is a diagram illustrating a configuration of a moving body 2 loaded with an entry system 1 of the present embodiment. The moving body 2 includes an entry controller 3 forming the entry system 1. The entry system 1 is loaded in the moving body 2, and enables a proper user of the moving body 2 to smoothly perform entry into the moving body 2. Here, “entry” to the moving body 2 refers at least to boarding (or getting into) the moving body 2 from outside of the moving body 2.

In the present embodiment, the moving body 2 is, for example, a passenger car, and may be a shared car that a plurality of persons can board. Yet, the moving body 2 is not limited to a passenger car, and may be an arbitrary moving body. Such a moving body may be, in addition to a land moving body such as a passenger car, a bus, a taxi, and a train, a marine moving body such as a ship and a submarine, or an air moving body such as an aircraft including an eVTOL (Electric Vertical Take-Off and Landing aircraft) and an airship.

On a right side part of the moving body 2, a right object detection sensor 4a that detects an object present on a right side of the moving body 2, a first right camera 5a and a second right camera 6a that photograph the right side of the moving body 2, and a right illuminator 7a that illuminates the right side of the moving body 2 are provided.

On a left side part of the moving body 2, a left object detection sensor 4b that detects an object present on a left side of the moving body 2, a first left camera 5b and a second left camera 6b that photograph the left side of the moving body 2, and a left illuminator 7b that illuminates the left side of the moving body 2 are provided.

On a rear part of the moving body 2, a rear object detection sensor 4c that detects an object present in a rear of the moving body 2, a first rear camera 5c and a second rear camera 6c that photograph the rear of the moving body 2, and a rear illuminator 7c that illuminates the rear of the moving body 2 are provided.

Hereinafter, the right object detection sensor 4a, the left object detection sensor 4b, and the rear object detection sensor 4c are noted as an object detection sensor 4 when not to be distinguished. In addition, the first right camera 5a, the first left camera 5b, and the first rear camera 5c are noted as a first camera 5 when not to be distinguished. Further, the second right camera 6a, the second left camera 6b, and the second rear camera 6c are noted as a second camera 6 when not to be distinguished. Also, the right illuminator 7a, the left illuminator 7b, and the rear illuminator 7c are noted as an illuminator 7 when not to be distinguished.

The second camera 6 has higher resolution and power consumption as compared with the first camera 5.

The first camera 5 and the second camera 6 are, for example, CCD cameras having different pixel numbers. In addition, the object detection sensor 4 is, for example, a ranging sensor capable of detecting a surrounding object and measuring a distance to the object, and is a millimeter wave radar in the present embodiment. The object detection sensor 4 is not limited to the radar, and may be an arbitrary ranging sensor capable of object detection and distance measurement. Such a sensor may be, in addition to a radar, a LiDar, or a sonar or the like.

The illuminator 7 can be formed using an arbitrary light emitter or light emitting element, for example. In the present embodiment, the illuminator 7 is, for example, an LED projector.

The moving body 2 also includes a door switch 9 provided in each of doors 8 of the moving body 2 to lock and unlock a door lock of the door 8 and to open and close the door 8. The door switch 9 may include an actuator that locks and unlock the door lock of the corresponding door 8 and an actuator that opens and closes the door 8.

In the present embodiment, the moving body 2 includes, as the doors 8 and the door switches 9, a right front door switch 9a provided on a driver's seat door 8a at a right front of the moving body 2, and a right rear door switch 9b provided on a right rear seat door 8b at a right rear of the moving body 2. In addition, the moving body 2 includes a left front door switch 9c provided on a passenger seat door 8c at a left front of the moving body 2, and a left rear door switch 9d provided on a left rear seat door 8d at a left rear of the moving body 2. The moving body 2 further includes a back door switch 9e provided on a back door (tailgate door) 8e of the moving body 2.

The moving body 2 also includes a communication device 10. The communication device 10 includes a transmitter-receiver for communicating with an electronic key 11 used to utilize the moving body 2. The electronic key 11 may be, for example, a smart key such as a FOB key, or a portable terminal such as a smartphone storing key information used to utilize the moving body 2.

### [2. Configuration of Entry System]

The configuration of the entry system 1 will be described.

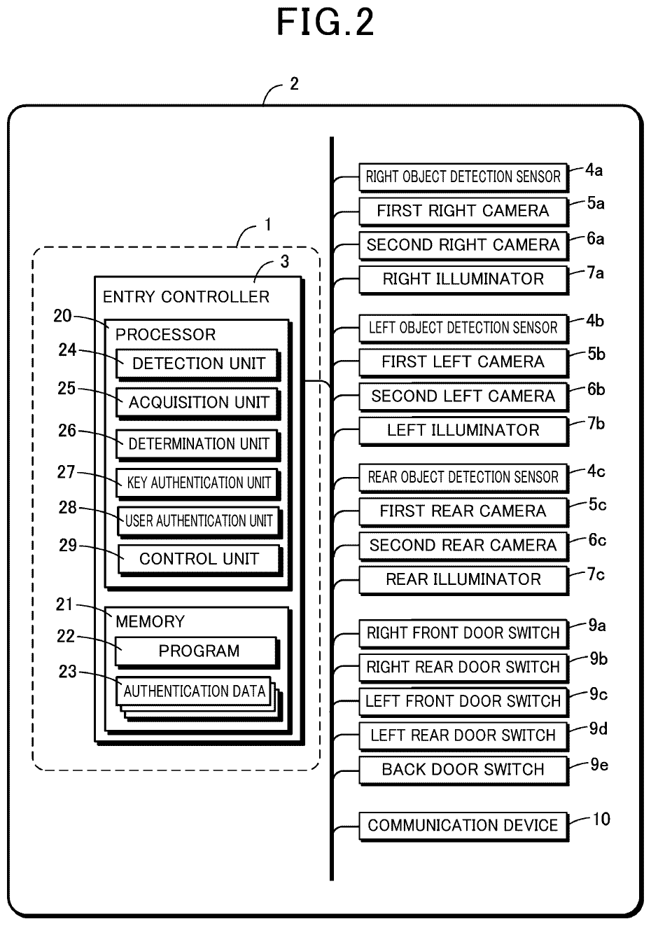

FIG. 2 is a diagram illustrating the configuration of the entry system 1. The entry system 1 at least includes the entry controller 3. In the present embodiment, in a case where an electronic key used for the moving body 2 is found and authentication of the electronic key is a success, when it is determined that a target person P who is an arbitrary person approaching the moving body 2 has an intention to board the moving body 2, the entry controller 3 enables the entry of the target person P to the moving body 2. In addition, in the case where the electronic key cannot be authenticated, when it is determined that the target person P has an intention to board the moving body 2, the entry controller 3 enables the entry of the target person P to the moving body 2 if authentication based on a face image of the target person P is a success.

Note that, hereinafter, a “target person” is a person defined as a target of the authentication by the entry system 1. In addition, a “user” is a registered user registered beforehand as a person who has proper authority to utilize the moving body 2, and is a person who actually utilizes the moving body 2. The target person P becomes the user when the target person P is authenticated by the entry controller 3 and the utilization of the moving body 2 is enabled.

Some of functional elements of the entry controller 3 indicated below may be provided in another device. For example, a control unit 29 (to be described later) provided in the entry controller 3 may be realized as a functional element of another electronic control unit (ECU) that controls an operation of the moving body 2. In this case, the entry system 1 includes the entry controller 3 and the electronic control unit, and the entry controller 3 communicates with the electronic control unit, and makes a function of the control unit 29 be executed in the electronic control unit.

The entry system 1 may also include other instruments such as the object detection sensor 4, the first camera 5 and the second camera 6 used by the entry controller 3.

The entry controller 3 includes a processor 20 and a memory 21. The memory 21 is formed of, for example, a volatile or nonvolatile semiconductor memory and/or a hard disk device or the like. In the memory 21, authentication data 23 is preserved for each of one, two or more registered users registered beforehand as persons who have the proper authority to utilize the moving body 2.

The processor 20 is a computer including a CPU or the like, for example. The processor 20 may be configured to include a ROM in which a program is written, and a RAM for temporarily storing data or the like. Then, the processor 20 includes, as the functional elements or functional units, a detection unit 24, an acquisition unit 25, a determination unit 26, a key authentication unit 27, a user authentication unit 28, and the control unit 29.

The functional elements provided in the processor 20 are realized by the processor 20 which is a computer executing a program 22 preserved in the memory 21. Note that the program 22 can be stored in an arbitrary computer-readable storage medium. Instead, all or some of the functional elements provided in the processor 20 may be formed of hardware including one or more electronic circuit components, respectively.

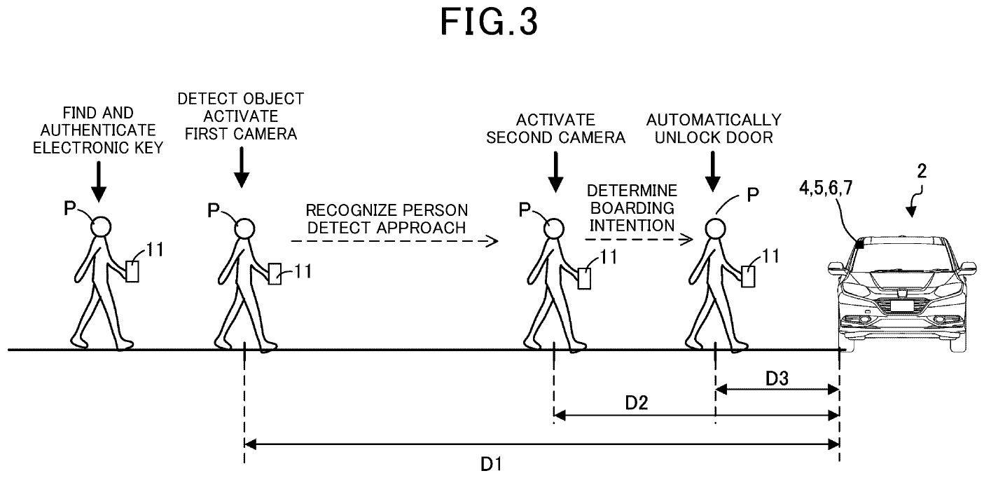

The detection unit 24 uses the object detection sensor 4 and the first camera 5 to detect the target person P approaching the moving body 2. The detection unit 24 is operated as illustrated in FIG. 3, for example. FIG. 3 is an explanatory diagram for describing the operation of the detection unit 24.

First, the detection unit 24 determines whether or not an entity (or an object) has entered a range of a prescribed distance D1 determined beforehand from the moving body 2 by the object detection sensor 4. The entity may be an arbitrary object including a living thing and a nonliving thing. When the entity has entered the range of the prescribed distance D1, the detection unit 24 activates the first camera 5 close to the object detection sensor 4 which has detected the entity.

The detection unit 24 successively acquires a first image around the moving body 2 by the activated first camera 5 at a prescribed time interval. The detection unit 24 performs image recognition processing for the first image photographed by the first camera 5, and determines whether or not the entity is a person. When the entity is a person, the detection unit 24 determines whether or not the person is approaching the moving body 2 from the first image successively photographed by the first camera 5. When the person is approaching the moving body 2, the detection unit 24 determines the person as the target person P. Thus, the detection unit 24 detects the target person P approaching the moving body 2. When the target person P is detected, the detection unit 24 notifies the acquisition unit 25 of that effect. In an example illustrated in FIG. 3, the detection unit 24 determines that the entity is a person approaching the moving body 2 while the entity detected by the object detection sensor 4 advances to a position at a distance D2 from the moving body 2, and notifies the acquisition unit 25 of that the target person P is detected when the person reaches the position at the distance D2.

When the target person P is detected in the detection unit 24, the acquisition unit 25 activates the second camera 6 near the first camera 5 used to detect the target person P, and acquires a second image of the target person P by the activated second camera 6 at the prescribed time interval. When it is dark around the moving body 2 at the time of activating the second camera 6, the acquisition unit 25 may light the illuminator 7 near the activated second camera 6.

As described above, the second camera 6 has higher resolution and power consumption as compared with the first camera 5.

The acquisition unit 25 successively photographs the high-definition second image of the target person P by the activated second camera 6 at the prescribed time interval. The acquisition unit 25 extracts the face image of the target person P from the second image every time the second image of the target person P is photographed, and acquires the plurality of face images of the target person P captured at the prescribed time interval. Every time the second image of the target person P is photographed, the acquisition unit 25 sends the photographed image of the target person P and the extracted face image to the determination unit 26 and the user authentication unit 28.

The determination unit 26 determines presence/absence of an intention of the target person P to board the moving body 2 based on movement of the target person P recognized from the plurality of second images captured at the prescribed time interval. For example, the determination unit 26 can determine that the target person P has an intention to board the moving body 2 when the target person P is approaching one of the doors 8 of the moving body 2 further, when the target person P stops in front of one of the doors 8 of the moving body 2, and when the target person P reaches his/her hand to a doorknob of one of the doors 8 or the like.

In an example illustrated in FIG. 3, the determination unit 26 determines the presence/absence of the boarding intention of the target person P at a position at a distance D3 from the moving body 2, for example.

The determination unit 26 notifies the user authentication unit 28 and the control unit 29 of a result of determining whether or not the target person P has an intention to board the moving body 2.

The key authentication unit 27 searches the electronic key 11 present around the moving body 2, and authenticates the electronic key 11. Specifically, the key authentication unit 27 transmits a response request for searching the electronic key 11 toward surroundings of the moving body 2 at all times by the communication device 10 according to conventional technology. When the target person P who has the electronic key 11 enters a reachable range of transmission radio waves of the response request, the electronic key 11 returns a requested response to the moving body 2 in response to reception of the response request. Thus, the key authentication unit 27 finds the electronic key 11. Thereafter, the key authentication unit 27 receives a key code from the electronic key 11, collates the received key code with a key code stored beforehand, and authenticates the electronic key 11. The electronic key 11 may be authenticated before the presence/absence of the boarding intention of the target person P is determined in the determination unit 26. The key authentication unit 27 notifies the user authentication unit 28 and the control unit 29 of a result on whether or not the authentication of the electronic key 11 is a success.

In the present embodiment, a communicable distance of the communication device 10 and the electronic key 11 is longer than a detectable distance of the object detection sensor 4. For example, in the example illustrated in FIG. 3, the key authentication unit 27 finds the electronic key 11 and completes the authentication for the electronic key 11 before the target person P who has the electronic key 11 reaches the position at the distance D1 from the moving body 2.

The user authentication unit 28 authenticates that the target person P is a registered user based on the face image of the target person P extracted from the second image. In the present embodiment, the user authentication unit 28 performs the authentication of the target person P based on the face image when it is determined that the target person P has the boarding intention in the determination unit 26, in the case where the electronic key 11 is not found or the authentication of the electronic key 11 is not a success in the key authentication unit 27.

Specifically, the user authentication unit 28 collates the face image of the target person P extracted from the second image by the acquisition unit 25 with the authentication data 23 of the registered user recorded in the memory 21 which is a storage device.

As described above, since the acquisition unit 25 sends the photographed image and the face image of the target person P to the user authentication unit 28 every time the second image of the target person P is photographed, the user authentication unit 28 can authenticate the target person P in parallel with acquisition of the second image in the acquisition unit 25. For example, in the example in FIG. 3, the user authentication unit 28 can operate so as to complete the authentication of the target person P at the position at the distance D3 at which the determination unit 26 completes determination on the presence/absence of the boarding intention of the target person P.

Specifically, the user authentication unit 28 calculates a feature amount of the face image for the face image acquired by the acquisition unit 25, and calculates, for each registered user, a collation score indicating a degree of coincidence between the calculated feature amount (target feature amount, hereinafter) and a feature amount (authentication feature amount, hereinafter) of the face image preserved in the authentication data 23 of each registered user stored in the memory 21.

Then, the user authentication unit 28 determines whether or not the target person P is one of the registered users based on the calculated collation scores. Specifically, for example, when there are collation scores equal to or higher than a first prescribed value in the calculated collation scores, the user authentication unit 28 authenticates that the target person P is the registered user corresponding to the collation score indicating a highest value among the collation scores equal to or higher than the first prescribed value. Thus, the authentication for the target person P becomes a success.

On the other hand, when there are not the collation scores equal to or higher than the first prescribed value in the calculated collation scores, the user authentication unit 28 determines that the target person P is not a registered user. Thus, the authentication for the target person P becomes a failure.

Here, the user authentication unit 28 may calculate the collation score for each of the plurality of face images of the target person P extracted respectively from the plurality of images acquired by the acquisition unit 25 at the prescribed time interval, and determine presence/absence of the registered user corresponding to the target person P based on the calculated collation score. In this case, when the registered user corresponding to the target person P determined for each of the plurality of face images is the same one registered user with a possibility of a predetermined value or higher in the plurality of face images, the user authentication unit 28 may determine that the target person P is the one registered user. When the one registered user cannot be specified, the user authentication unit 28 can determine that the target person P is not a registered user.

When authenticating the target person P, the user authentication unit 28 may perform so-called liveness determination on whether or not the face image acquired for the target person P is an image of an actual face of the target person P. When it is determined that the acquired face image is not the image of the actual face of the target person P himself/herself and is, for example, an image of a head part of a third person wearing a mask printed with a face photo is printed or the like in the liveness determination, the user authentication unit 28 may determine that the authentication using the face image is a failure.

Specifically, the user authentication unit 28 may authenticate whether or not the target person P is a registered user based on the face images on condition that respective hues of the face images extracted from each of the plurality of images successively captured from the second camera 6 by the detection unit 24 at the prescribed time interval and/or time-sequential brightness distribution change of the face images satisfies a predetermined standard, for example. Here, for example, the standard may be that the hue that the face image has is not the hue peculiar to a printed matter and/or that illumination to the face of the target person P recognized from the plurality of time-sequential face images successively changes without inconsistency, or the like.

Thus, for example, it is possible to effectively prevent the target person P who intends to perform unauthorized entry into the moving body 2, for example, by wearing a mask printed with a face image of a registered user who is a different person.

In addition, the user authentication unit 28 may authenticate that the target person P is a registered user on condition that a gesture made by the target person P coincides with an authentication gesture registered beforehand, based on the plurality of images successively captured from the second camera 6 by the detection unit 24 at the prescribed time interval. The authentication gesture may be formed of time-sequential images acquired from the registered user beforehand and preserved in the memory 21, for example.

Thus, the target person P can be more appropriately authenticated based also on the gesture of the target person P.

Note that a face image acquisition operation in the acquisition unit 25 and an authentication operation based on the acquired face image in the user authentication unit 28 can be performed in parallel with an image acquisition operation from the second camera 6 in the detection unit 24.

The control unit 29 controls the operation of the moving body 2.

In the present embodiment, in particular, in the case where the authentication of the electronic key 11 is a success in the key authentication unit 27, when the determination unit 26 determines that the target person P has the boarding intention, the control unit 29 instructs the door switch 9 of the moving body 2 to automatically unlock the door 8. Specifically, when a notice indicating that the authentication of the electronic key 11 is a success is received from the key authentication unit 27 and also a notice indicating that the target person P has the boarding intention is received from the determination unit 26, the control unit 29 instructs the door switch 9 to automatically unlock the door 8.

At the time, the control unit 29 may instruct the door switch 9 to execute an automatic opening operation of automatically opening the door 8 after instructing the door switch 9 to automatically unlock the door 8. The control unit 29 may execute automatic unlocking and the automatic opening operation with the door 8 closest to the target person P as a target, for example. The door 8 closest to the target person P can be specified from the lately acquired second image and notified to the control unit 29 by the acquisition unit 25, for example.

In addition, when the electronic key 11 is not found or the authentication of the electronic key 11 is not a success in the key authentication unit 27, the control unit 29 may automatically unlock the door 8 of the moving body 2 when the determination unit 26 determines that the target person P has the boarding intention and the authentication of the target person P in the user authentication unit 28 is a success. Specifically, for example, in the case where the notice indicating that the authentication of the electronic key 11 is a success is not received from the key authentication unit 27, the control unit 29 instructs the door switch 9 to automatically unlock the door 8 when the notice indicating that the target person P has the boarding intention is received from the determination unit 26 and also the notice indicating that the authentication of the target person P in the user authentication unit 28 is a success is received.

Further, in the case where the authentication of the electronic key 11 is a success in the key authentication unit 27, if the determination unit 26 does not determine that the target person P has the boarding intention, the control unit 29 may instruct the door switch 9 to automatically unlock the door 8 when the electronic key 11 enters a prescribed distance range from the moving body 2. The position of the electronic key 11 can be detected, for example, from reception strength of radio waves from the electronic key 11 received by the communication device 10 from each of antennas (not illustrated in FIG. 1) distributed and disposed on a body of the moving body 2 according to the conventional technology. The key authentication unit 27 can start detection of the position of the electronic key 11 when the authentication of the electronic key 11 is a success, and notify the control unit 29 of the detected position of the electronic key 11.

### [3. Operation of Entry System]

Next, a procedure of the operation of the entry system 1 will be described.

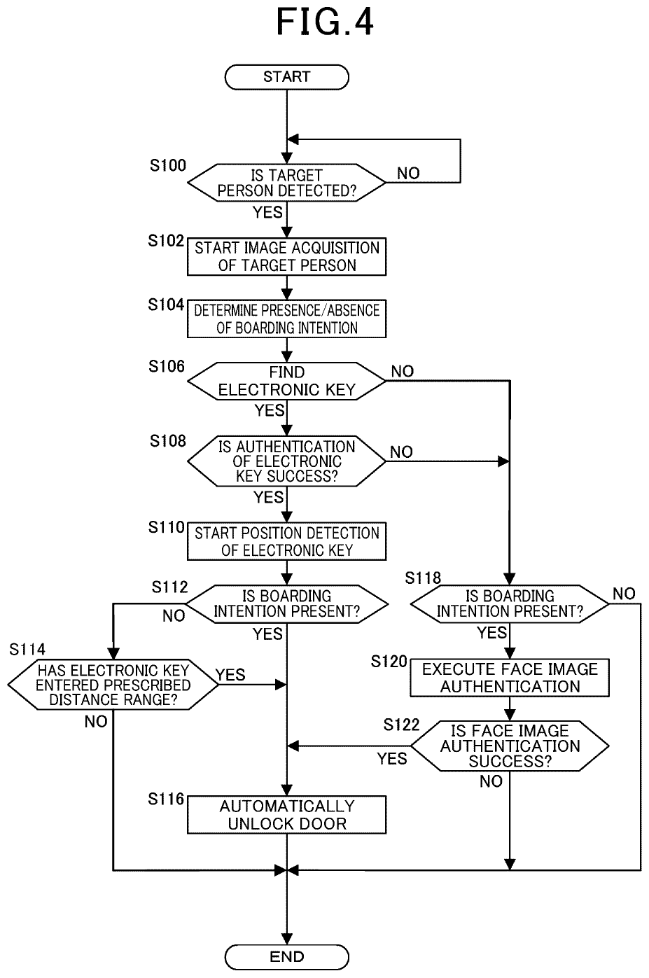

FIG. 4 is a flowchart illustrating a procedure of an entry control method executed by a computer of the entry system 1. The computer of the entry system 1 is the processor 20 of the entry controller 3 as an example in the present embodiment.

Processing illustrated in FIG. 4 is started when power sources of respective instruments illustrated in FIG. 2 including the entry controller 3 are turned on, and is repeatedly executed. Note that the key authentication unit 27 executes a search for the electronic key 11 at all times in parallel with the processing illustrated in FIG. 4.

When the processing is started, first, the detection unit 24 determines whether or not the target person P approaching the moving body 2 is detected (S100). As described above, the detection unit 24 can detect the target person P using the object detection sensor 4 and the first camera 5. Then, when the target person P is not detected (S100, NO), the detection unit 24 returns to step S100 and repeats the processing.

On the other hand, when the target person P is detected (S100, YES), the acquisition unit 25 starts the acquisition of the second image of the target person P by the second camera 6 (S102). Thereafter, the acquisition unit 25 repeatedly acquires the second image of the target person P at the prescribed time interval. In addition, the acquisition unit 25 sends the photographed image of the target person P and the face image of the target person P extracted from the second image to the determination unit 26 and the user authentication unit 28 every time the second image of the target person P is photographed.

The determination unit 26 determines whether or not the target person P has the intention to board the moving body 2 based on the image of the target person P captured by the acquisition unit 25 (S104). The determination unit 26 notifies the user authentication unit 28 and the control unit 29 of the result of determining the presence/absence of the boarding intention.

The key authentication unit 27 determines whether or not the electronic key 11 is found by a search for the electronic key 11 present around the moving body 2 (S106). Then, when the electronic key 11 is found (S106, YES), the key authentication unit 27 executes the authentication of the electronic key 11, and determines whether or not the authentication of the electronic key 11 is a success (S108). The key authentication unit 27 notifies the user authentication unit 28 and the control unit 29 of an authentication result on whether or not the authentication of the electronic key 11 is a success.

Then, when the authentication of the electronic key 11 is a success (S108, YES), the key authentication unit 27 starts position detection of the electronic key 11 (S110). The key authentication unit 27 detects the position of the electronic key 11 at the prescribed time interval, and notifies the control unit 29 of the detected position of the electronic key 11.

Next, the control unit 29 determines whether or not the result of determining the boarding intention of the target person P made by the determination unit 26 in step S104 indicates the presence of the boarding intention (S112). Then, when the result of determining the boarding intention of the target person P indicates the presence of the boarding intention (S112, YES), the control unit 29 instructs the door switch 9 to automatically unlock the door 8 (S116), and ends the present processing.

On the other hand, when the result of determining the boarding intention of the target person P does not indicate the presence of the boarding intention (S112, NO), the control unit 29 determines whether or not the electronic key 11 has entered the range of the predetermined prescribed distance from the moving body 2 based on information of the position of the electronic key 11 notified from the key authentication unit 27 (S114). For example, the control unit 29 can determine that the electronic key has entered the range of the prescribed distance when the position of the electronic key 11 enters the range of the prescribed distance from the moving body 2 within predetermined prescribed time after the notice indicating that the authentication of the electronic key 11 is a success is received from the key authentication unit 27. Further, for example the control unit 29 can determine that the electronic key has not entered the range of the prescribed distance when the position of the electronic key 11 does not enter the range of the prescribed distance from the moving body 2 within the prescribed time after the notice indicating that the authentication of the electronic key 11 is a success is received from the key authentication unit 27.

Then, if the electronic key has entered the range of the prescribed distance (S114, YES), the control unit 29 moves the processing to step S116, and automatically unlocks the door 8. On the other hand, if the electronic key 11 has not entered the range of the prescribed distance (S114, NO), the control unit 29 ends the present processing without automatically unlocking the door 8.

Meanwhile, when the key authentication unit 27 does not find the electronic key 11 in step S106 (S106, NO) or the authentication of the electronic key is not a success in step S108 (S108, NO), the user authentication unit 28 determines whether or not the result of determining the boarding intention of the target person P made by the determination unit 26 in step S104 indicates the presence of the boarding intention (S118). For example, the user authentication unit 28 can execute step S118 when the notice indicating that the authentication of the electronic key 11 is a success is not received from the key authentication unit 27 before the notice of the result of determining the presence/absence of the boarding intention of the target person P is received from the determination unit 26.

Then, when the result of determining the boarding intention of the target person P does not indicate the presence of the boarding intention (S118, NO), the user authentication unit 28 ends the present processing.

On the other hand, when the result of determining the boarding intention of the target person P indicates the presence of the boarding intention (S118, YES), the user authentication unit 28 authenticates the target person P based on the face image of the target person P from the acquisition unit 25 (S120). The user authentication unit 28 notifies the control unit 29 of the result of face image authentication for the target person P.

Subsequently, when a result notice of the face image authentication for the target person P is received from the user authentication unit 28, the control unit 29 determines whether or not the face image authentication of the target person P in the user authentication unit 28 is a success (S122). Then, when the face image authentication of the target person P is a success (S122, YES), the control unit 29 moves the processing to step S116, automatically unlocks the door 8, and ends the present processing. On the other hand, when the face image authentication of the target person P is not a success (S122, NO), the control unit 29 ends the present processing without automatically unlocking the door 8.

After the present processing is ended, the processor 20 of the entry controller 3 repeats the processing from step S100 anew.

Here, in FIG. 4, steps S100 and S102 correspond to a detection step and an acquisition step in the present disclosure. In addition, steps S104 and S108 correspond to a determination step and a key authentication step in the present disclosure. Further, step S116 corresponds to a control step in the present disclosure.

Note that the present invention is not limited to the configuration of the embodiments described above, and can be implemented in various modes without deviating from the gist.

[5. Configurations Supported by Embodiments Described above]

The embodiments described above support the following configurations.

(Configuration 1) An entry system including: a detection unit configured to detect a target person approaching a moving body; an acquisition unit configured to acquire an image of the target person at a prescribed time interval; a determination unit configured to determine presence/absence of a boarding intention of the target person to the moving body based on movement of the target person recognized from the image; a key authentication unit configured to search an electronic key present around the moving body and to authenticate the electronic key; and a control unit configured to control an operation of the moving body, wherein when authentication of the electronic key is a success in the key authentication unit, the control unit automatically unlocks a door of the moving body when the determination unit determines that the target person has the boarding intention.

According to the entry system of configuration 1, it is possible to enable a proper user of the moving body to smoothly perform entry into the moving body without complicating authentication processing.

(Configuration 2) The entry system according to configuration 1, wherein the key authentication unit authenticates the electronic key before the determination unit determines presence/absence of the boarding intention of the target person.

According to the entry system of configuration 2, it is possible to simultaneously authenticate the target person by the electronic key and determine the presence/absence of the boarding intention of the target person without delay and to enable the target person who is a proper user of the moving body to smoothly perform entry into the moving body, without complicating the authentication processing.

(Configuration 3) The entry system according to configuration 1 or 2, further including a user authentication unit configured to authenticate that the target person is a registered user based on a face image of the target person extracted from the image, wherein when the electronic key is not found in the key authentication unit or authentication of the electronic key is not a success, the user authentication unit authenticates the target person based on the face image of the target person when the determination unit determines that the target person has the boarding intention, and the control unit automatically unlocks the door of the moving body when the authentication of the target person in the user authentication unit is a success.

According to the entry system of configuration 3, even when the electronic key cannot be authenticated, by alternatively conducting the authentication by the face image of the target person, it is possible to realize smooth entry of the user who intends to board the moving body.

(Configuration 4) The entry system according to any one of configurations 1 to 3, wherein in a case where authentication of the electronic key is a success in the key authentication unit, when the determination unit does not determine that the target person has the boarding intention, the control unit automatically unlocks the door of the moving body when the electronic key for which the authentication is a success enters a prescribed distance range from the moving body.

According to the entry system of configuration 4, even in the case where the boarding intention of the target person to the moving body cannot be correctly recognized based on the movement of the target person recognized from the image, it is possible to determine from the position of the electronic key carried by the target person that the target person is approaching right close to the moving body and is clearly showing the boarding intention, and to realize the smooth entry of the user who is the target person.

(Configuration 5) The entry system according to any one of configurations 1 to 4, wherein the moving body includes a ranging sensor, a first camera, and a second camera having a resolution higher than a resolution of the first camera, the detection unit acquires a first image at a prescribed time interval from the first camera when it is detected that an object has entered a prescribed distance range from the moving body by the ranging sensor, and when it is determined that the object is a person approaching the moving body based on the acquired first image, detects the person as the target person, the acquisition unit acquires a second image of the target person at the prescribed time interval by the second camera when the target person is detected in the detection unit, and the determination unit determines presence/absence of the boarding intention of the target person based on the movement of the target person recognized from the second image.

According to the entry system of configuration 5, it is possible to increase power consumption in a series of operations from recognition of an approaching object as a target person to acquisition of the face image of the target person stepwise according to detection accuracy required for the operations while reducing the power consumption in an object approach standby period. Therefore, according to the entry system of configuration 5, unneeded power consumption can be suppressed while securing processing accuracy of the operation until the entry of the user to the moving body.

(Configuration 6) An entry control method conducted by a computer of an entry system that controls unlocking of a door of a moving body, the method including: a detection step of detecting a target person approaching the moving body; an acquisition step of acquiring an image of the target person at a prescribed time interval; a determination step of determining presence/absence of a boarding intention of the target person to the moving body based on movement of the target person recognized from the image; a key authentication step of searching an electronic key present around the moving body and authenticating the electronic key; and a control step of controlling an operation of the moving body, wherein in the control step, when authentication of the electronic key is a success in the key authentication step, the door of the moving body is automatically unlocked when it is determined that the target person has the boarding intention in the determination step.

According to the entry control method of configuration 6, it is possible to enable a proper user of the moving body to smoothly perform entry into the moving body without complicating the authentication processing.

### REFERENCE SIGNS LIST

1 . . . entry system, 2 . . . moving body, 3 . . . entry controller, 4 . . . object detection sensor, 4a . . . right object detection sensor, 4b . . . left object detection sensor, 4c . . . rear object detection sensor, 5 . . . first camera, 5a . . . first right camera, 5b . . . first left camera, 5c . . . first rear camera, 6 . . . second camera, 6a . . . second right camera, 6b . . . second left camera, 6c . . . second rear camera, 7 . . . illuminator, 7a . . . right illuminator, 7b . . . left illuminator, 7c . . . rear illuminator, 8 . . . door, 8a . . . driver's seat door, 8b . . . right rear seat door, 8c . . . passenger seat door, 8d . . . left rear seat door, 8e . . . back door, 9 . . . door switch, 9a . . . right front door switch, 9b . . . right rear door switch, 9c . . . left front door switch, 9d . . . left rear door switch, 9e . . . back door switch, 10 . . . communication device, 20 . . . processor, 21 . . . memory, 22 . . . program, 23 . . . authentication data, 24 . . . detection unit, 25 . . . acquisition unit, 26 . . . determination unit, 27 . . . key authentication unit, 28 . . . user authentication unit, 29 . . . control unit.

1. An entry system comprising:
a detection unit configured to detect a target person approaching a moving body;
an acquisition unit configured to acquire an image of the target person at a prescribed time interval;
a determination unit configured to determine presence/absence of a boarding intention of the target person to the moving body based on movement of the target person recognized from the image;
a key authentication unit configured to search an electronic key present around the moving body and to authenticate the electronic key; and
a control unit configured to control an operation of the moving body,
wherein when authentication of the electronic key is a success in the key authentication unit, the control unit automatically unlocks a door of the moving body when the determination unit determines that the target person has the boarding intention.

2. The entry system according to claim 1,
wherein the key authentication unit authenticates the electronic key before the determination unit determines presence/absence of the boarding intention of the target person.

3. The entry system according to claim 1, further comprising
a user authentication unit configured to authenticate that the target person is a registered user based on a face image of the target person extracted from the image,
wherein when the electronic key is not found in the key authentication unit or authentication of the electronic key is not a success,
the user authentication unit authenticates the target person based on the face image of the target person when the determination unit determines that the target person has the boarding intention, and
the control unit automatically unlocks the door of the moving body when the authentication of the target person in the user authentication unit is a success.

4. The entry system according to claim 1,
wherein in a case where authentication of the electronic key is a success in the key authentication unit, when the determination unit does not determine that the target person has the boarding intention,
the control unit
automatically unlocks the door of the moving body when the electronic key for which the authentication is a success enters a prescribed distance range from the moving body.

5. The entry system according to claim 1,
wherein the moving body includes a ranging sensor, a first camera, and a second camera having a resolution higher than a resolution of the first camera,
the detection unit acquires a first image at a prescribed time interval from the first camera when it is detected that an object has entered a prescribed distance range from the moving body by the ranging sensor, and when it is determined that the object is a person approaching the moving body based on the acquired first image, detects the person as the target person,
the acquisition unit acquires a second image of the target person at the prescribed time interval by the second camera when the target person is detected in the detection unit, and
the determination unit determines presence/absence of the boarding intention of the target person based on the movement of the target person recognized from the second image.

6. An entry control method conducted by a computer of an entry system that controls unlocking of a door of a moving body, the method comprising:
a detection step of detecting a target person approaching the moving body;
an acquisition step of acquiring an image of the target person at a prescribed time interval;
a determination step of determining presence/absence of a boarding intention of the target person to the moving body based on movement of the target person recognized from the image;
a key authentication step of searching an electronic key present around the moving body and authenticating the electronic key; and
a control step of controlling an operation of the moving body,
wherein in the control step, when authentication of the electronic key is a success in the key authentication step, the door of the moving body is automatically unlocked when it is determined that the target person has the boarding intention in the determination step.
